(19) United States
(12) Patent Application Publication
(10) Pub. No.: US 2009/0300879 A1
(43) Pub. Date: Dec. 10, 2009

(54) DOOR STOPPER FOR VEHICLES

(75) Inventor: Sam Seok JANG, Ulsan (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/336,438

(22) Filed: Dec. 16, 2008

(30) Foreign Application Priority Data
Jun. 4, 2008 (KR) 10-2008-0052624

(51) Int. Cl. E05F 5/00

(52) U.S. Cl. 16/82

(57) ABSTRACT

A door stopper for a vehicle may include a male stopper mounted to a vehicle body and having an insert end portion; a female stopper mounted to a vehicle door and having a receiving space therein with an opening so that the insert end portion of the male stopper is removably inserted into the receiving space through the opening; and a rotary slider rotatably provided in the receiving space of the female stopper such that the rotary slider is rotated by the insert end portion of the male stopper being inserted into the receiving space and thus a sidewall of the insert end portion is pushed by the rotary slider toward the female stopper.

### CROSS-REFERENCE TO RELATED APPLICATION

The present application claims priority to Korean Patent Application Number 10-2008-0052624 filed Jun. 4, 2008, the entire contents of which application is incorporated herein for all purposes by this reference.

### BACKGROUND OF THE INVENTION

1. Field of the Invention

The present invention relates to a door stopper for vehicles which can prevent a sliding door from being misaligned from a vehicle body when the sliding door is closed.

2. Description of Related Art

Generally, sliding doors, which are opened or closed in a sliding manner, are used in van type vehicles to facilitate entrance or exit of passengers in relatively small space. Such sliding doors promote convenience of passengers and the stability of vehicles.

As shown in FIGS. 7 and 8, a typical sliding door 10 is coupled to a vehicle body 40 such that it is slidable along a rail 20, which is installed in the vehicle body behind a driver's seat and extends in a longitudinal direction of the vehicle body. The sliding door 10 includes a roller 30, which is provided so as to be rotatable along the rail 20. Furthermore, the sliding door 10 includes a female stopper 52, which corresponds to a male stopper 51 provided in the vehicle body 40 in a traverse direction thereof.

However, because the sliding door may move in a lateral direction of the vehicle by a gap between the rail and the roller when the sliding door is opened or closed, the sidewalls of the male stopper and the female stopper may come into excessive contact with each other. Thereby, the surface of the stopper may become deteriorated.

In an effort to overcome this problem, a technique in which the female and male stoppers are made of synthetic resin such as TPO has been proposed. However, in this case, when a vehicle is turned or travels on an uneven surface, noise occurs due to friction between the female and male stoppers made of TPO material.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a door stopper for vehicles which prevents noise from occurring due to friction when a sliding door is closed.

In an aspect of the present invention, a door stopper for a vehicle may include a male stopper mounted to a vehicle body and having an insert end portion, a female stopper mounted to a vehicle door and having a receiving space therein with an opening so that the insert end portion of the male stopper is removably inserted into the receiving space through the opening, and/or a rotary slider rotatably provided in the receiving space of the female stopper such that the rotary slider is rotated by the insert end portion of the male stopper being inserted into the receiving space and thus a sidewall of the insert end portion is pushed by the rotary slider toward the female stopper.

The rotary slider may include a body portion provided in the receiving space of the female stopper and being rotatably coupled to a stationary member, a contact portion protruding from a first portion of the body portion and extending sufficiently enough to be pushed by the insert end portion of the male stopper as the male stopper and the female stopper are coupled together, and/or a push portion protruding from a second portion of the body portion and extending sufficiently enough to push the sidewall of the insert end portion of the male stopper toward the female stopper as the male stopper and the female stopper are coupled together.

The stationary member may be the vehicle door.

The stationary member may be the female stopper.

The body portion may be rotatably coupled to the stationary member by a rotating shaft provided on the body portion.

The contact portion and the push portion may have a predetermined angle therebetween with respect to the body portion.

Diameter of the receiving space may be equal to or smaller than diameter of the contact portion of the rotary slider.

The door stopper for vehicles as set forth in claim 2, further including a roller provided in the push portion of the rotary slider, wherein the roller rolls along the sidewall of the insert end portion of the male stopper according to rotation of the contact portion.

The insert end portion of the male stopper may include a roller seating depression to receive the roller therein.

The roller may be made of elastic material.

The door stopper for the vehicle may farther include a protrusion provided at upper surface of the push portion of the rotary slider.

The protrusion may be made of elastic material.

The insert end portion of the male stopper may be inclined at a predetermined angle with a movement direction of the male stopper. Inner surface of the opening of the female stopper may be inclined with substantially the same angle as the predetermined angle of the insert portion of the male stopper.

The vehicle door may include a sliding door.

The opening of the female stopper may have a width sufficiently enough to avoid contacting the insert end portion of the male stopper

The male stopper and/or the female stopper may be made of elastic material.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary door stopper for vehicles according to the present invention.

FIG. 2 is a perspective view of a female stopper of the door stopper of FIG. 1.

FIG. 3 is a perspective view of a rotary slider of the door stopper of FIG. 1.

FIG. 4 is a perspective view of a roller of the door stopper of FIG. 1.

FIGS. 5A and 5B are views illustrating the operation of the door stopper of FIG. 1.

FIGS. 6A and 6B are views illustrating the operation of an exemplary door stopper for vehicles according to the present invention.

FIG. 7 is a view showing the construction of a conventional door stopper for vehicles.

FIG. 8A is a sectional view taken along the line “A-A” of FIG. 7.

FIG. 8B is a sectional view taken along the line “B-B” of FIG. 7.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

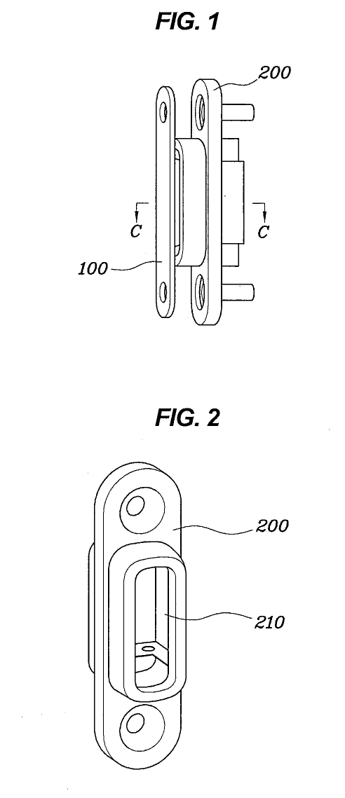

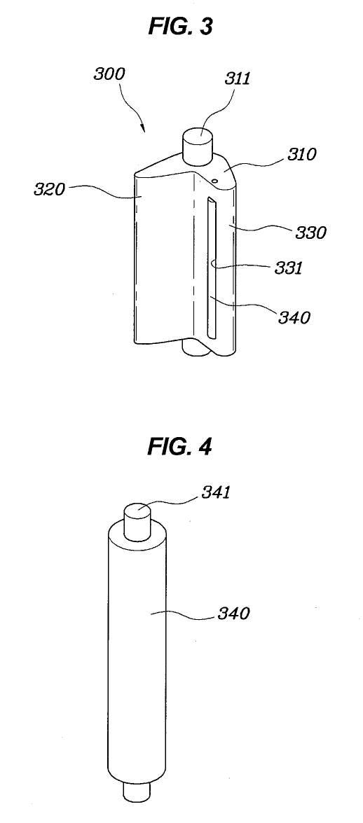

As shown in FIGS. 1 through 4, a door stopper according to various exemplary embodiments of the present invention is characterized in that a rotary slider 300 which is rotated by a male stopper 100 is provided in a female stopper 200 so that noise is prevented from being generated by friction attributable to relative movement between the male stopper 100 and the female stopper 200.

In detail, to achieve the above purpose, the door stopper according to various embodiments of the present invention includes a male stopper 100, a female stopper 200 which is fitted into the male stopper 100, and a rotary slider 300 which is provided in the female stopper 200. Preferably, the door stopper having the above construction is used in a van type vehicle, the doors of which are opened or closed in a sliding manner, but the present invention is not limited to this. In other words, the construction of the present invention can be applied to all vehicles having openable doors.

The male stopper 100 is mounted to a vehicle body at a position corresponding to the female stopper 200 of the sliding door. In addition, the male stopper 100 has an insert end portion 110, which is removably inserted into the female stopper 200.

The insert end portion 110 comes into direct contact with the female stopper 200 to function as the stopper. It is preferable that the insert end portion 110 be inclined at a predetermined angle to ensure smooth rotation of the rotary slider 300 in the female stopper 200.

When the insert end portion 110 of the male stopper 100 is inclined at a predetermined angle relative to the direction in which the male stopper 100 is inserted into the female stopper 200, a rotation operation whereby the rotary slider 300 is rotated by the insert end portion 110 and the sidewall of the insert end portion 110 is pushed by the rotation of the rotary slider 300 can be conducted more smoothly, as compared to a structure in which an insert end portion of a male stopper is parallel to the direction of the movement of the male stopper.

Furthermore, since the insert end portion 110 of the male stopper 100 is inclined at a predetermined angle relative to the direction in which the male stopper 100 is inserted into the female stopper 200, when the female stopper 200 of the sliding door is moved to be decoupled from the male stopper 100, the insert end portion 110 pushes downwards the push portion 300 of the rotary slider 300 and thus the rotary slider 300 rotates in the anti-clockwise direction. Accordingly, the male stopper 100 can be smoothly decoupled from the female stopper 200.

In various embodiments of the present invention, the male stopper 100 and/or the female stopper 200 may be made of a rubber such that the insert end portion 110 made of rubber may supply elastic force to return the push portion 330 of the rotary slider 300 to the original position as the male stopper 100 is decoupled from the female stopper 200.

The female stopper 200 is mounted to the sliding door at a position corresponding to the main stopper 100 so that when the sliding door is closed, the male stopper 100 of the vehicle body is fitted into the female stopper 200. The female stopper 200 has a receiving space 210, into which the insert end portion 110 of the male stopper 100 is inserted. Here, because the insert end portion 110 of the male stopper 100 has a shape that is inclined at a predetermined angle, it is preferable that a mouth 211 of the receiving space 210 be relatively wide to prevent impeding the movement of the insert end portion 110.

The rotary slider 300 is provided in the receiving space 210. The rotary slider 300, which is a rotary body installed in the receiving space 210, includes a body portion 310, a contact portion 320 and a push portion 330.

In detail, the body portion 310 is placed in the receiving space 210 and is coupled to the female stopper 200 so as to be rotatable around a rotating shaft 311 formed on the body portion 310. The contact portion 320 and the push portion 330 respectively extend from first and second portions of the body portion 310.

When the male stopper 100 is inserted into the female stopper 200, the contact portion 320, which protrudes from the first portion of the body portion 310, is pushed inwards by the insert end portion 110 of the male stopper 100, thus rotating in the clockwise direction in the drawing the rotary slider 300 around the rotating shaft 311.

The push portion 330 protrudes from the second portion of the body portion 310. The push portion 330 pushes the sidewall of the insert end portion 110 upwards when the rotary slider 300 is pushed and rotated by the insert end portion 110. A roller seating depression 331 may be formed in a portion of the push portion 330 which contacts the sidewall of the insert end portion 110. A roller 340 is placed in the roller seating depression 331. In various embodiments of the present invention, the roller 340 is made of rubber.

Here, the roller 340 is provided in the roller seating depression 331 so as to be rotatable. Therefore, when the push portion 330 pushes the sidewall of the insert end portion 110, the roller 340 rolls on the sidewall of the insert end portion 110, thus reducing the friction between the sidewall of the insert end portion 110 and the rotary slider 300.

The operation of the door stopper of the present invention having the above-mentioned construction will be explained herein below.

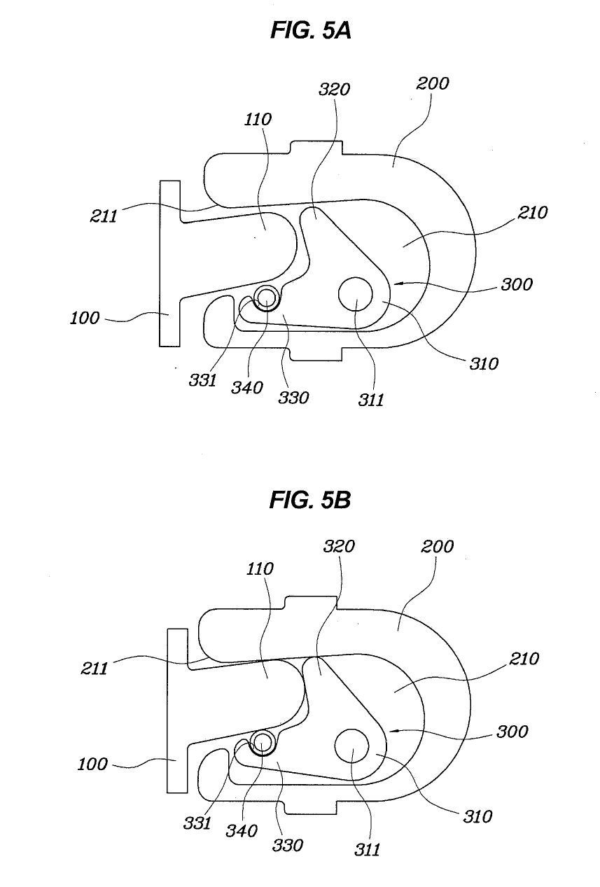

As shown in FIG. 5A, when the sliding door is closed, the male stopper 100 of the vehicle body is inserted into the female stopper 200 of the sliding door.

At this time, as shown in FIG. 5B, the insert end portion 110 of the male stopper 100 pushes and rotates the rotary slider 300 in the female stopper 200 and then is seated into the receiving space of the female stopper 200. Therefore, a problem of friction noise attributable to contact between the male stopper 100 and the female stopper 200 can be solved.

That is, when the insert end portion 110 of the male stopper 100 is inserted into the receiving space 210, the insert end portion 110 pushes the contact portion 320 of the rotary slider 300 and thus rotates the rotary slider 300. The push portion 330 of the rotary slider 300 pushes the sidewall of the insert end portion 110 by the rotation of the rotary slider 300. At this time, the roller 340 of the push portion 330 rolls on the sidewall of the insert end portion 110. A portion of the sidewall of the insert end portion 110 which is on the opposite side from the roller 340 is brought into close contact with the inner surface of the female stopper 200. Hence, in various embodiments of the present invention, the rotary slider 300 provided in the female stopper 200 can prevent friction noise from occurring attributable to contact movement between the male stopper 100 and the female stopper 200.

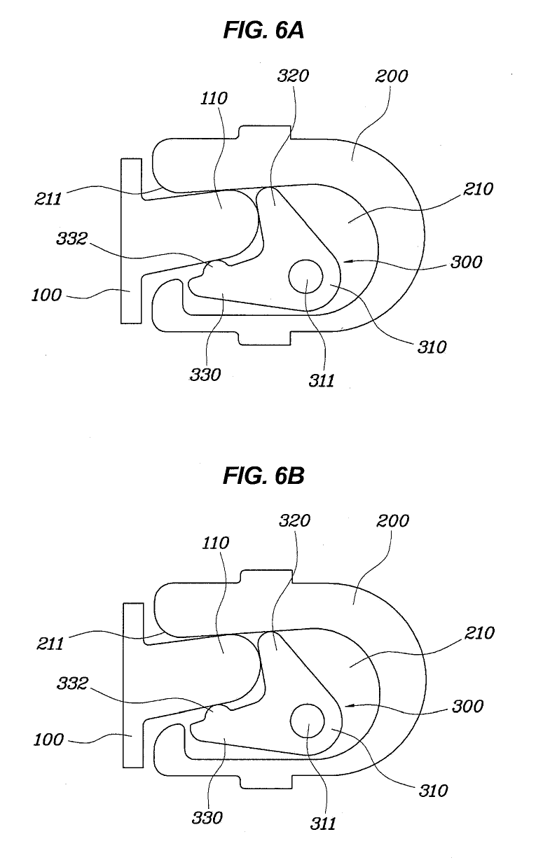

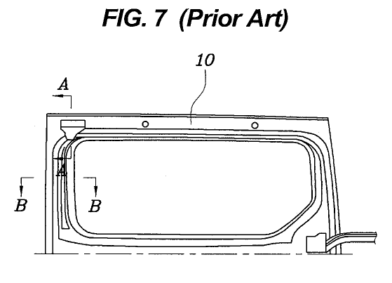

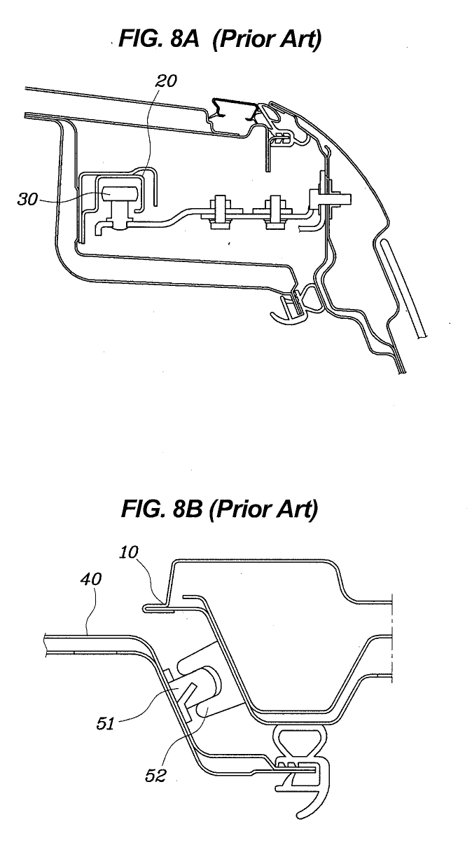

FIG. 6A and 6B illustrates a door stopper for vehicles, according to other embodiments of the present invention. As shown in FIG. 6A, a rotary slider 300 according to various embodiments includes a body portion 310, a contact portion 320 and a push portion 330. Unlike some embodiments, a protrusion 332 may be provided on the push portion 330 without having a separate roller. The protrusion 332 may be made of an elastic material such as rubber.

Referring to FIG. 6B, in various embodiments, when the rotary slider 300 is rotated by insertion of the insert end portion 110 of the male stopper 100 into the receiving space 210, the protrusion 332 of the push portion 330 pushes the sidewall of the insert end portion 110 by the rotation of the rotary slider 300. Thus, a portion of the sidewall of the insert end portion 110 which is opposite the protrusion 332 is brought into close contact with the inner surface of the female stopper 200.

As described above, the present invention provides a door stopper for vehicles which is constructed such that a rotary slider provided in a female stopper can prevent friction noise from occurring due to contact occurring during movement between a male stopper and the female stopper.

For convenience in explanation and accurate definition in the appended claims, the term “inner” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door stopper for a vehicle, comprising:
a male stopper mounted to a vehicle body and having an insert end portion;
a female stopper mounted to a vehicle door and having a receiving space therein with an opening so that the insert end portion of the male stopper is removably inserted into the receiving space through the opening; and
a rotary slider rotatably provided in the receiving space of the female stopper such that the rotary slider is rotated by the insert end portion of the male stopper being inserted into the receiving space and thus a sidewall of the insert end portion is pushed by the rotary slider toward the female stopper.

2. The door stopper for the vehicle as set forth in claim 1, wherein the rotary slider comprises:
a body portion provided in the receiving space of the female stopper and being rotatably coupled to a stationary member;
a contact portion protruding from a first portion of the body portion and extending sufficiently enough to be pushed by the insert end portion of the male stopper as the male stopper and the female stopper are coupled together; and
a push portion protruding from a second portion of the body portion and extending sufficiently enough to push the sidewall of the insert end portion of the male stopper toward the female stopper as the male stopper and the female stopper are coupled together.

3. The door stopper for the vehicle as set forth in claim 1, wherein the stationary member is the vehicle door.

4. The door stopper for the vehicle as set forth in claim 1, wherein the stationary member is the female stopper.

5. The door stopper for the vehicle as set forth in claim 2, wherein the body portion is rotatably coupled to the stationary member by a rotating shaft provided on the body portion.

6. The door stopper for the vehicle as set forth in claim 2, wherein the contact portion and the push portion have a predetermined angle therebetween with respect to the body portion.

7. The door stopper for the vehicle as set forth in claim 2, wherein diameter of the receiving space is equal to or smaller than diameter of the contact portion of the rotary slider.

8. The door stopper for the vehicle as set forth in claim 2, further comprising a roller provided in the push portion of the rotary slider, wherein the roller rolls along the sidewall of the insert end portion of the male stopper according to rotation of the contact portion.

9. The door stopper for the vehicle as set forth in claim 8, wherein the insert end portion of the male stopper includes a roller seating depression to receive the roller therein.

10. The door stopper for the vehicle as set forth in claim 8, wherein the roller is made of elastic material.

11. The door stopper for the vehicle as set forth in claim 2, further comprising a protrusion provided at upper surface of the push portion of the rotary slider.

12. The door stopper for the vehicle as set forth in claim 11, wherein the protrusion is made of elastic material.

13. The door stopper for the vehicle as set forth in claim 2, wherein the insert end portion of the male stopper is inclined at a predetermined angle with a movement direction of the male stopper.

14. The door stopper for the vehicle as set forth in claim 13, wherein inner surface of the opening of the female stopper is inclined with substantially the same angle as the predetermined angle of the insert portion of the male stopper.

15. The door stopper for the vehicle as set forth in claim 1, wherein the vehicle door comprises a sliding door.

16. The door stopper for the vehicle as set forth in claim 1, wherein the opening of the female stopper has a width sufficiently enough to avoid contacting the insert end portion of the male stopper.

17. The door stopper for the vehicle as set forth in claim 1, wherein the male stopper and/or the female stopper is made of elastic material.

18. A passenger vehicle comprising the door stopper as set forth in claim 1.
